(19) United States
(12) Patent Application Publication
(10) Pub. No.: US 2026/0273769 A1
(43) Pub. Date: Sep. 17, 2026

(54) MULTI-POSITION FINISHING SYSTEM

(71) Applicant: Sargent Manufacturing Company, New Haven, CT (US)

(72) Inventors: Miguel Angel Alvarez Rábago, Guadalajara (MX); Luis Manuel Betancourt Agredano, Tlaquepaque (MX); David Martinez Diaz, Tlajomulco De Zuñiga (MX)

(73) Assignee: Sargent Manufacturing Company, New Haven, CT (US)

(21) Appl. No.: 19/549,222

(22) Filed: Feb. 25, 2026

Related U.S. Application Data
(60) Provisional application No. 63/771,920, filed on Mar. 14, 2025.

(51) Int. Cl. B25J 11/00; B25J 9/00; B25J 9/16; B25J 19/00

(52) U.S. Cl. CPC B25J 11/005; B25J 9/0018; B25J 9/0096; B25J 9/1664; B25J 19/0075

(57) ABSTRACT

A multi-position robotic finishing systems having the ability to perform a variety of finishing processes on an article of manufacture is disclosed. The system may effectively prevent debris from damaging robotic or otherwise moving components.

### CROSS-REFERENCE TO RELATED APPLICATIONS

This application claims the benefit of priority under 35 U.S.C. § 119(e) to U.S. Provisional Application Serial No. 63/771,920 filed on Mar. 14, 2025, which is hereby incorporated by reference in its entirety.

### FIELD

Disclosed embodiments are related to finishing methods for finishing of articles of manufacture.

### BACKGROUND

Articles of manufacture for hardware such as handles, escutcheons, or other components for door locks may be finished by a variety of finishing methods such as sanding, grinding, polishing or painting. Such finishing methods may be performed manually by a user and a finishing device. These processes have become increasingly automated to utilize robotics to improve accuracy and consistency. These processes often produce excess debris, such as burrs, aerosols, or other particulates.

### SUMMARY

In some embodiments, a multi-position finishing system is provided. The multi-position finishing system may include a base, a frame coupled to the base, and a robotic arm operatively coupled to the frame approximately opposite the base. The robotic arm may be configured to hold an article of manufacture for finishing with at least one finishing process. The multi-position finishing system may further include at least one finishing assembly operatively coupled to the base that may perform at least one finishing process on the article of manufacture and create a least one form of waste, and a disposal system coupled to the base. The disposal system may be configured to collect the at least one form of waste produced from the finishing process.

In some embodiments, a method for finishing an article of manufacture is provided. The method for finishing an article of manufacture may include securing an article of manufacture with a robotic arm. The robotic arm may manipulate a position of an article of manufacture towards a finishing assembly. The method may further include orienting the article of manufacture to a first orientation, performing a finishing process on the article of manufacture, while the article of manufacture is held in the first orientation, and activating a disposal system. The disposal system may be configured to move debris from the finishing process away from the robotic arm.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a perspective view of a multi-position finishing system according to an embodiment;

FIG. 2 shows a side view of the multi-position finishing system of FIG. 1 in a first orientation;

FIG. 3 shows a side view of the multi-position finishing system of FIG. 1 in a second orientation;

FIG. 4 shows a side view of the multi-position finishing system of FIG. 1 in a third orientation;

FIG. 5A-5C show a top view of the finishing assembly of FIG. 2 moving between two orientations;

FIG. 6 shows a side view of the multi-position finishing system of FIG. 1 in a fourth orientation; and

FIG. 7 shows a side view of the multi-position finishing system according to another embodiment in a first orientation.

### DETAILED DESCRIPTION

Articles of manufacture such as door handles, escutcheons or other hardware components may be finished by a variety of finishing processes including, but not limited to grinding, polishing, sanding, or painting. Such processes can be performed manually, however they have become increasingly automated by automatic finishing systems. Many modern manufacturing processes may incorporate robotics to help finish articles of manufacture throughout a manufacturing process. In addition, a variety of motors and actuators may be incorporated into finishing assemblies or devices to rapidly perform processes or swap between different finishing processes. Automating these finishing processes may improve efficiency, accuracy and consistency in the manufacturing process. In addition, these finishing processes may be beneficial for finishing articles of manufacture having complex shapes or curvatures, or articles of manufacture requiring multiple finishing processes. These finishing processes may produce a variety of debris either removed from the article of manufacture or from a finishing device. Such debris may be particulate matter, aerosols, or gasses for example. These debris may inhibit robotics systems or finishing assemblies from properly functioning by clogging moving parts, corroding components, or otherwise damaging the systems.

The Inventors have found that such debris may lead to failures in the robotics or finishing assemblies resulting in delays or errors in the manufacturing process. Accordingly, the Inventors have invented a system that overcomes these deficiencies. The Inventors have appreciated that it may be desirable for automated finishing systems to remove debris from finishing processes, before the debris can cause damage to components within the system. The components of the system may be arranged to limit exposure of the debris in combination with an additional removal system.

In some embodiments of a multi-position finishing system, the automated finishing system may have a base, and a frame coupled to the base. The frame may contain at least a robotic arm (also referred to herein as a manipulator) configured to hold or position an article of manufacture, a finishing assembly configured to perform at least one finishing process on an article of manufacture, and a disposal system configured to remove debris or waste from at least one finishing process. In addition, at least one controller may be used to control at least the robotic arm, finishing assembly, and/or disposal system. The robotic arm may manipulate the position of an article of manufacture relative to a finishing assembly, so that the finishing assembly may perform a finishing process on the article of manufacture in a variety of orientations. It should be appreciated that such an arrangement allows for the system to more easily finish articles of manufacture with complex contours such as door handles, or escutcheons. Upon the production of debris or waste from the finishing process, it may be desirable to activate a disposal system to remove debris or waste from the vicinity of the robotic arm or finishing assembly to prevent debris or waste from damaging the robotic arm or finishing assembly.

In some embodiments the robotic arm may be operatively coupled to the frame of the multi-position finishing system. The robotic arm may be configured to hold and manipulate the position of a variety of articles of manufacture. The robotic arm may be configured to operate with six degrees of freedom to position an article of manufacture in a plurality of orientations, however robots with either more or less degrees of freedom are also contemplated. The robotic arm may be configured to manipulate the position of an article of manufacture relative to a finishing device, so that a finishing process may be performed on the article of manufacture. The robotic arm may be further coupled to the frame approximately opposite the base and may be in an inverted position above the base. It should be appreciated that by positioning the robotic arm above the base, debris from the finishing process may fall away from the robotic arm. Alternatively, the robotic arm may be positioned in a variety of orientations that position at least some of the joints of the robot away from finishing processes. For example, the robotic arm may be coupled to a side of the frame. It should be appreciated that the robotic arm may further be able to move articles of manufacture between different finishing assemblies or manufacturing locations.

In some embodiments, articles of manufacture may be finished by a finishing assembly. It should be appreciated that the finishing assembly may perform a variety of finishing processes, and these processes are not limiting. For example, the finishing assembly may perform processes such as grinding, sanding, sand blasting, painting, cutting, or other manufacturing processes on an article of manufacture. It should be appreciated that a single finishing assembly may be able to perform a plurality of finishing processes with a plurality of finishing devices. For example, a finishing assembly may consist of a sanding belt and an orbital sander. In some embodiments, it may be desirable for the finishing assembly to be moveable relative to the robotic arm, so that the robotic arm may more easily access different finishing devices. The finishing assembly may be connected to an actuator to either rotate or translate relative to the finishing system. It should be appreciated that different finishing devices may perform different finishing processes. Alternatively, different finishing devices may perform similar finishing processes in different configurations to perform a finishing process on different curvatures. For example, a finishing assembly may have a first finishing device being a flat sander, and a second finishing device being a curved sander with similar grit. It should be appreciated that finishing assemblies may support a plurality of finishing devices and combinations of finishing devices to optimize any manufacturing processes.

In some embodiments, the multi-position finishing system may further comprise a disposal system. It may be desirable to remove debris from the finishing process to limit damage on components such as the robotic arm or any actuators in the finishing system. In addition, it may be desirable to remove debris from the finishing process to make it easier to finish the articles of manufacture. The Inventors have appreciated that it may be desirable to integrate disposal system into the base of the finishing system, positioned opposite the robot may effectively remove debris from the finishing process. Other orientations of the disposal system may also be desirable. Alternatively, the disposal system may not be integrated into the base. For example, the disposal system may be integrated into the frame to move debris away from the robotic arm and the finishing assembly. In addition, there may be multiple disposal systems incorporated into the finishing system. The disposal system may include a funnel or other collection machine. The funnel may be directly integrated into the base or positioned on top of the base, adjacent to the base, or into the frame. In some embodiments, the funnel may be coupled to a suction device fluidly coupled to the disposal system for removing particulate matter or other debris from a volume surrounding the finishing assembly. In some embodiments, the device may be a vacuum or other suction device, configured to pull debris towards the funnel. Alternatively, other pump arrangements may be used to force debris away from the finishing assembly and the robotic arm through the funnel. In yet another embodiment, a fan or similar device for blowing air and debris may be incorporated into the disposal system to blow debris towards the funnel or an exhaust system. It should be appreciated that the fan may be situated opposite of the funnel so that debris may move away from the robotic arm and finishing assembly. In addition, the Inventors have appreciated that it may be desirable for the disposal system to have an exhaust connected to the device for removing particulate matter. The exhaust may direct debris away from the finishing system.

In addition, the Inventors have appreciated that it may be desirable to coordinate the movement of the robotic arm, with the changing of finishing processes through the finishing assembly and the activation of the disposal system. Coordinating the separate components of the finishing system may allow for more efficient finishing by performing multiple finishes on a single part without needing to relocate the part or otherwise replace finishing components. A controller may be used to coordinate the components of the finishing assembly or optimize power usage or cycle time usage. It should be appreciated that the controller may additionally control each individual component. For example, the controller may manipulate the robotic arms position, actuate the grabbing or releasing of an article of manufacture, or orienting the article of manufacture relative the finishing assembly.

In addition, the controller may reposition or reorient the finishing assembly to switch between multiple finishing processes. The controller may initiate a finishing process and then actuate an actuator coupled to the finishing assembly to reposition the finishing assembly relative to the article of manufacture, so that the finishing assembly may perform a second finishing process after the first finishing process is completed. The controller may also control different parameters of the finishing device in the finishing assembly. For example, the controller may control the speed of an orbital sander, or the pressure applied to an article of manufacture, or the pressure of a sand blaster.

The controller may further position the finishing assembly to perform further finishing processes on the article of manufacture. In addition, the controller may actuate the disposal system to remove debris when desired. For example, if the debris exceeds a predetermined threshold the controller may activate the disposal system to remove debris. In addition, if there are multiple disposal systems, the controller may actuate each disposal system individually, for example it may be desirable for different disposal systems to remove different debris from different finishing processes at different times. In addition, it may be desirable for the controller to control different parameters of the disposal system. For example, the controller may control the strength of a vacuum to optimize the removal of debris or minimize noise.

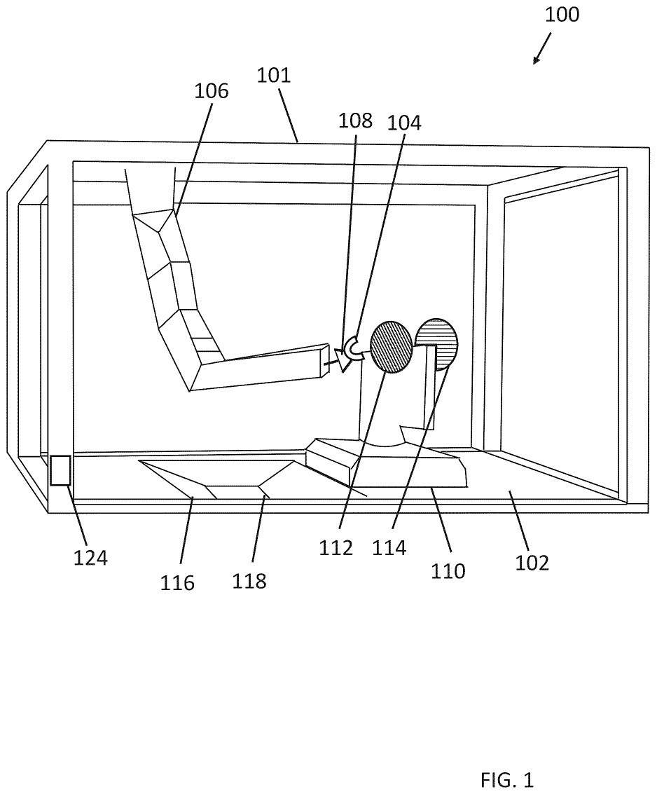

Turning to FIGS. 1-7, specific non-limiting embodiments are described in further detail. It should be understood that the various systems, components, features, and methods described relative to these embodiments may be used either individually and/or in any desired combination as the disclosure is not limited to only the specific embodiments described herein.

FIG. 1 depicts one embodiment of a multi-position finishing system 100 having a frame 101, a base 102 for finishing an article of manufacture 104. The article of manufacture 104 may be a door handle, knob, escutcheon, or other architectural hardware for a door, however it should be appreciated that the article of manufacture is not limited to architectural hardware and other articles of manufacture are also considered. The multi-position finishing system 100 may have at least one robotic arm 106 configured to hold or secure the article of manufacture 104 with a gripper 108 or similar structure and manipulate the position of the article of manufacture 104 relative to a finishing assembly 110 as the finishing assembly 110 performs a finishing process on the article of manufacture 104. It should be appreciated that while a surface finishing process is depicted, the system may perform other manufacturing processes including but not limited to cutting, sand blasting or painting on the article of manufacture.

It should be appreciated that the robotic arm 106 may be a six degree of freedom robot so that the robotic arm 106 may manipulate position and article of manufacture 104 in a variety of orientations. However, it should be appreciated that higher degree of freedom robotic systems are also contemplated to improve manipulability and reduce the possibility of singularities. In addition, lower degree of freedom robotic systems are contemplated to simplify operations or reduce cost. In addition, the robotic arm 106 and gripper 108 may grab and release the article of manufacture 104 in a variety of orientations, allowing for the robotic arm 106 to reposition an article of manufacture 104 and finish different portions of the article of manufacture 104, or for the robotic arm 106 to move the article of manufacture 104 to a further manufacturing step, or for the robotic arm 106 to grab a new article of manufacture. The robotic arm 106 may be coupled to a portion of the frame 101 opposite the base 102 or away from the finishing assembly 110. The robotic arm 106 is depicted being coupled to a top portion of the frame 101 and being inverted so that the robotic arm 106 extends gravitationally downwards from the point where the robotic arm 106 couples to the frame 101. It should be appreciated that the orientation of the robotic arm 106 is not limiting and in some embodiments, it may be desirable to couple the robotic arm to any side of the frame or the base to avoid exposure to debris. It should be appreciated that the robotic arm may be oriented in a variety of orientations so that debris from the finishing process do not damage the robotic arm 106.

The robotic arm 106 may manipulate the position of the article of manufacture 104 so that finishing devices such as a first or second sander 112, 114, of the finishing assembly 110 may perform finishing processes on the article of manufacture 104. The first sander 112 may be an orbital sander with a course grit configured to provide a rough finish on the article of manufacture 104. The second sander 114 may be an orbital sander having a fine grit configured to polish the article of manufacture 104 or otherwise provide a different finishing process. It should be appreciated that the finishing devices are not limited to orbital sanders, finishing devices such as sand blasters, paint sprayers, belt sanders, or other finishing devices are also contemplated. In addition, the finishing devices may perform different variations of the same finishing process. For example, the finishing devices may use a sander but have different grits. In an alternative embodiment, the finishing devices may perform the same finishing process, however the finishing devices may have a substantially different forms to finish differently shaped portions of an article of manufacture. For example, a finishing assembly may have a finishing device having a spindle sander and a finishing device having a belt sander having the same grit. Each finishing device may provide a similar finish on an article of manufacture on different contours. In yet another embodiment, the finishing devices may perform different finishing processes. For example, a first finishing device may sand an article of manufacture, and a second finishing device may cut the article of manufacture. The amount of finishing devices of a finishing assembly is not limiting, and it should be appreciated that a finishing assembly may have various combinations or amounts of finishing devices. In addition, it may be desirable for the finishing assembly to be able to reposition so that the robotic arm 106 may more easily access different finishing devices to perform different finishing processes on the article of manufacture 104.

The Inventors have appreciated that sanders 112 and 114 may produce a variety of debris. Debris may form from the removal of material from the article of manufacture 104, or the wear on the sanders 112 and 114, and may be substantially particulate matter. It should be appreciated that other finishing devices may produce debris including but not limited to aerosols, particulate matter, or forms of waste from finishing processes. These debris may damage moving components in both the robotic arm 106 and finishing assembly 110. In addition, debris may inhibit finishing processes or pose health risks to users in vicinity of the system. The system may include a disposal system 116 configured to remove debris from the system. It should be appreciated that the disposal system 116 may have a funnel configured to collect a large amount of debris and a suction device configured to pull debris into the funnel 118 away from the robotic arm 106.

In addition, the finishing system 100 may further have a controller 124, configured to control the robotic arm 106, the finishing assembly 110, the disposal system 116, or a combination of the above. It should be appreciated that the controller 124 may be directly integrated into the frame 101, separate from the frame 101, or be directly integrated into other components of the system. In addition, the controller 124 may be connected to the components through either a wired or wireless connection.

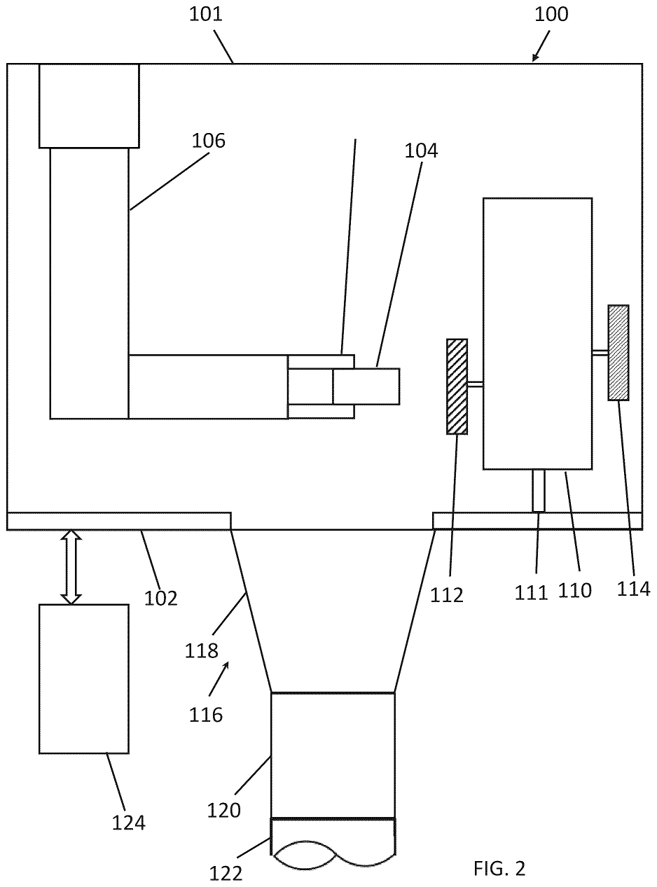

FIG. 2 depicts a side profile of the system in a first position where the robotic arm 106 is holding an article of manufacture 104 with grippers 108 away from the finishing assembly 110. The finishing assembly 110 may be in a first finishing position, so that the first sander 112 is oriented towards the article of manufacture 104. The first sander 112 may have a relatively coarse grit to perform a rough finish on the article of manufacture 104. The controller 124 may control the finishing assembly 110 by activating the first sander 112 so that the first sander 112 may rotate at a desired speed. The controller 124 may also control the direction or other parameters of the first sander 112.

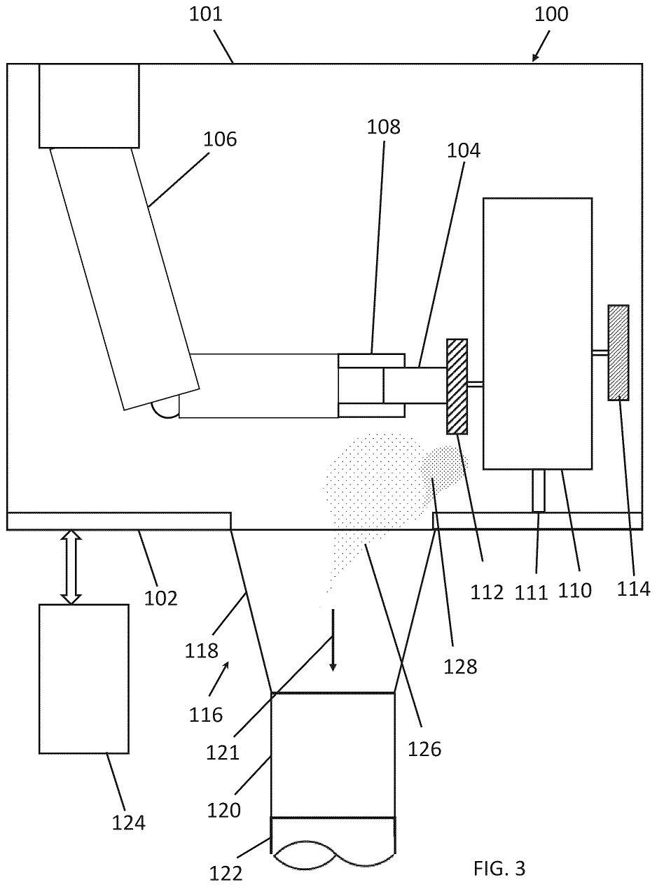

The controller 124 may activate the first sander 112 and manipulate the robotic arm 106 to move the article of manufacture 104 towards the first sander 112, as shown in FIG. 3, so that a portion of the surface of the article of manufacture 104 contacts the first sander 112. Upon contact, the first sander 112 may finish the surface of the article of manufacture 104. It should be appreciated that in some embodiments, it may not be necessary for the article of manufacture 104 to contact a finishing device. For example, if the finishing device is a paint sprayer, the article of manufacture 104 may only need to be positioned relatively near the finishing device. The robotic arm 106 may be controlled by the controller 124. It may be beneficial for a single controller 124 to control both the robotic arm 106 and the finishing assembly 110 to coordinate the position of the article of manufacture 104 with the activation of a finishing device. It should be appreciated that in some embodiments it may be desirable to activate a finishing device prior to properly positioning the article of manufacture 104, and in other embodiments, it may be desirable to properly position the article of manufacture 104 prior to activating a finishing device. In addition, the position of the article of manufacture 104 may be changed during a finishing process by the robotic arm 106 so that the finishing process may be performed over an entire desired portion of the article of manufacture 104. It should be appreciated that while a surface finishing process is depicted, the system may perform other manufacturing processes such as cutting or drilling on the article of manufacture 104. The robotic arm 106 may also place and pick up the article of manufacture 104 to reposition the article of manufacture relative to the finishing assembly 110.

Once the first sander 112 begins to sand the article of manufacture 104, material is removed from the surface of the article of manufacture 104 resulting in a first debris 126. In addition, the sanding process may also wear the sander 112 creating a second debris 128. Both debris 126 and 128 may damage the robotic arm 106 by clogging, wearing, or otherwise damaging any moving components in the robotic arm 106. In addition, the buildup of debris around the article of manufacture 104, may inhibit the finishing process, reducing the uniformity of the sanding or other finishing processes. It may be desirable for a disposal system 116 to remove the debris 126 and 128 from the finishing system 100 to reduce the impact of the debris on the system 100 and process. The disposal system 116 may be integrated into the base 102. Alternatively, the disposal system may be integrated into the frame 101 or other portions of the system. It should be appreciated that the disposal system 116 may be configured to move debris away from the robotic arm 106. The disposal system 116 may have a funnel 118 configured to collect debris 126 and 128 from a large area and funnel it away from the robotic arm 106. In addition, the disposal system may have a vacuum 120 configured to create a negative pressure to move the debris 126 and 128 with a force as indicated by arrow 121. It should be appreciated that other means of moving debris are also contemplated including fans, or pumps, or fluid compressors.

The disposal system 116 may be fluidly coupled to an exhaust 122 configured to remove debris away from the finishing system 100. The exhaust 122 may transport debris to a waste receptacle or other disposal system for proper disposal. It should be appreciated that the controller 124 may also control the actuation or power of the vacuum 120 to activate the disposal system 116. In other embodiments, it may be desirable to provide multiple disposal systems to more efficiently remove debris from the finishing system 100.

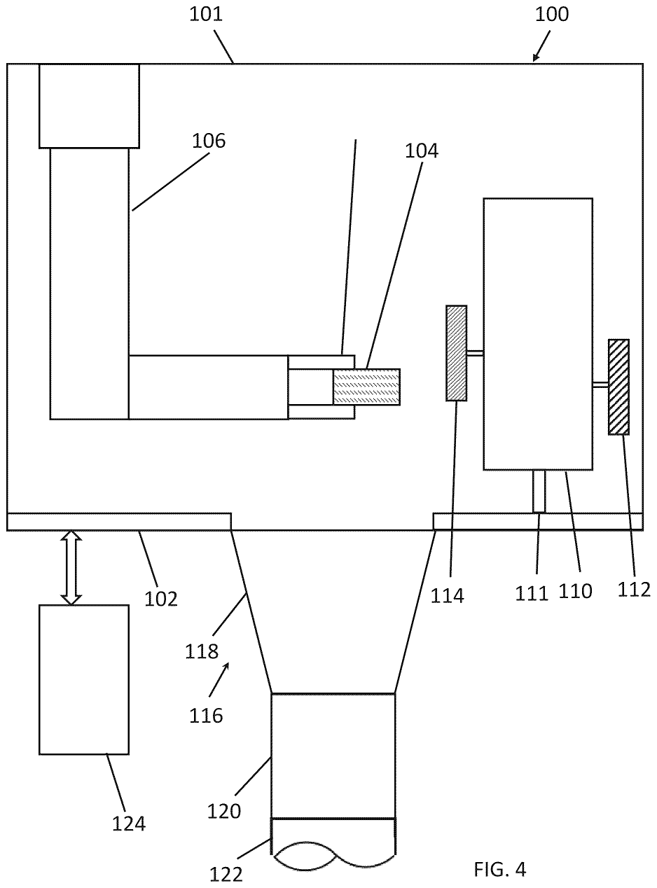

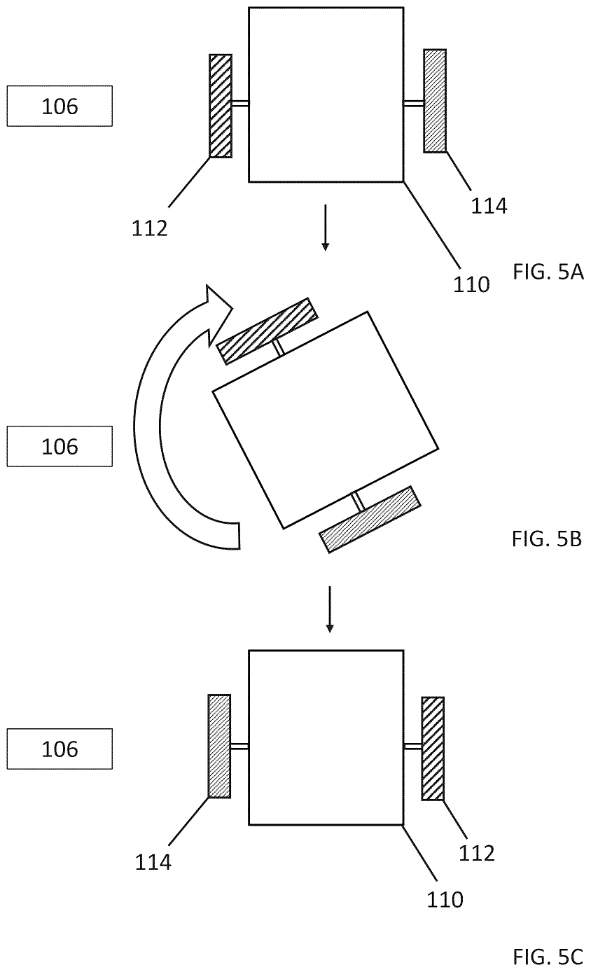

After the first sander 112 performs the sanding process on the desired portion of the article of manufacture 104, it may be desirable to perform a second finishing process on the article of manufacture 104. FIG. 4 illustrates the robotic arm 106 having returned the article of manufacture 104 to the initial position after the first sander 112 sanded at least a portion of the article of manufacture. It should be appreciated that once the article of manufacture 104 is sufficiently away from the finishing assembly 110, the finishing assembly 110 may be repositioned by the controller 124. In FIG. 4, the finishing assembly 110 has been rotated about an axis by a rotary actuator 111 controlled by the controller 124 so that the second sander 114 is positioned towards the article of manufacture 104. FIGS. 5A-C illustrate a top view of the finishing assembly 110 rotating from a first position in FIG. 5A where the first sander 112 is oriented towards the robotic arm 106 (simplified in FIGS. 5A-5C) to a second position FIG. 5C where the second sander 114 is oriented towards the robotic arm 106. By rotating the finishing assembly 110 it should be appreciated that the same robotic arm 106 may perform multiple finishing processes on an article of manufacture without needing to significantly reposition the article of manufacture, this may improve the speed and efficiency of the manufacturing process. In addition, FIGS. 5A-C illustrates the finishing assembly rotating approximately 180 degrees to reposition the first and second sanders. It should be appreciated that in some embodiments the finishing assembly may rotate in different increments due to having additional finishing devices, or finishing devices spaced apart differently. In yet another embodiment, the finishing assembly may translate linearly to reposition finishing devices relative to the robotic arm. It should be appreciated that the controller may coordinate the movement of the finishing assembly with the robotic arm to effectively perform a variety of finishing processes on an article of manufacture.

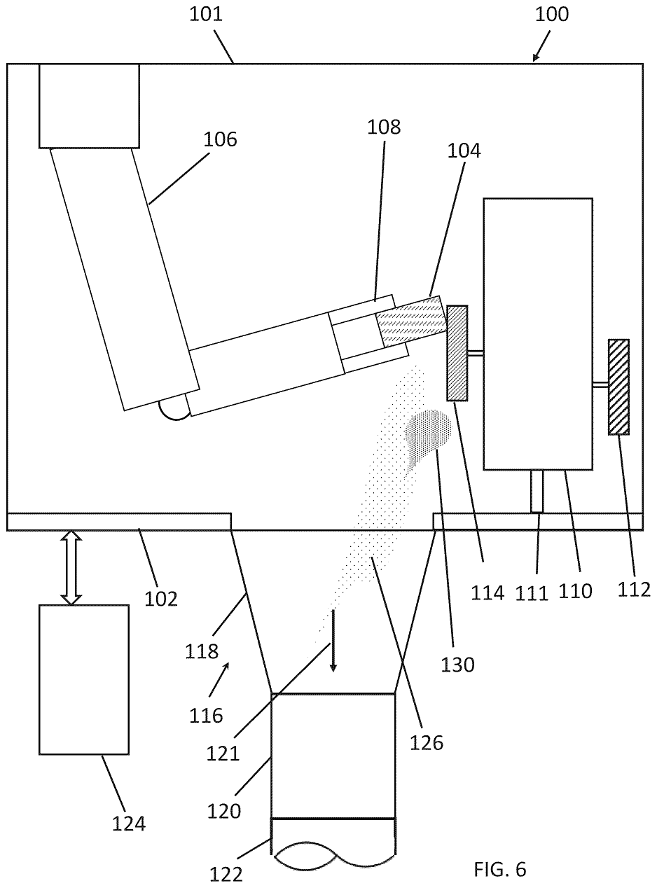

Once the finishing assembly 110 is in a second position, as shown in FIG. 6 the second sander 114 may be oriented towards the robotic arm 106. The second sander 114 may have a relatively fine grit to perform a second finishing process to sand the article of manufacture 104 to effectively polish the article of manufacture 104. The controller 124 may control the finishing assembly 110 by activating the second sander 114 so that the second sander 114 may rotate at a desired speed. The controller 124 may also control the direction or other parameters of the second sander 114. The controller 124 may further control the robotic arm 106, while holding the article of manufacture 104 in the grippers 108 to contact the article of manufacture 104 with the second sander 114. This allows the second sander 114 to sand the surface of the article of manufacture 104 to polish the surface of the article of manufacture 104. The robotic arm 106 may continue to move the article of manufacture 104 to sand a desired portion of the surface of the article of manufacture 104.

It should be appreciated that similarly to the first finishing process, the second finishing process may also produce debris including additional quantities of the first debris 126 from the removal of material from the article of manufacture 104 and a third debris 130 from the wear of the second sander 114. It may still be desirable for the controller 124 to activate the disposal system 116 to remove the first and third debris 126 and 130. The disposal system 116 may function similarly as it had to remove the first and second debris from the first finishing process. The controller 124 may activate a vacuum 120 once debris begins to form to draw the debris away from the robotic arm 106 and other moving components to a funnel 118. The vacuum 120 may then dispose of the first and third debris 126 and 130 through an exhaust 122.

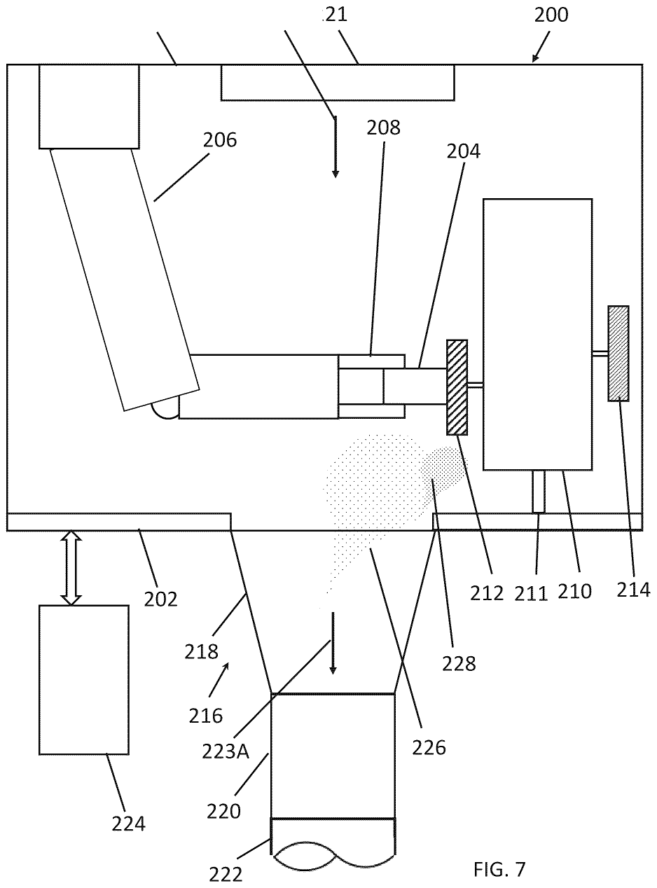

The Inventors have further appreciated that it may be desirable to provide additional means for moving debris for disposal from a multi-position finishing system. FIG. 7 illustrates yet another embodiment of a multi-position finishing system 200 having a frame 201, a base 202 for finishing an article of manufacture 204. The multi-position finishing system 200 may have at least one robotic arm 206 configured to hold the article of manufacture 204 with a gripper 208 or similar structure and manipulate the position of the article of manufacture 204 relative to a finishing assembly 210. The finishing assembly 210 may perform a finishing process on the article of manufacture 204. The robotic arm 206 may manipulate the position of the article of manufacture 204 so that finishing devices such as a first or second finishing device 212, 214, of the finishing assembly 210 may perform finishing process on the article of manufacture 204. A controller 224 may activate the first finishing device 212 and move the robotic arm 206 to move the article of manufacture 204 towards the first finishing device 212, so that a portion of the surface of the article of manufacture 204 contacts the first finishing device 212. Upon contact, the first finishing device 212 may finish the surface of the article of manufacture 204.

Once the first finishing device 212 begins to finish the article of manufacture 204, material may be removed from the surface of the article of manufacture 204 resulting in a first debris 226. In addition, the finishing process may also produce a second debris 228 from the first finishing device 212. Both debris 226 and 228 may damage the robotic arm 206 by clogging or otherwise damaging any moving components in the robotic arm 206. In addition, the buildup of debris around the article of manufacture 204, may inhibit the finishing process, reducing the uniformity of the finish. It may be desirable for a disposal system 216 to remove the debris 226 and 228 from the finishing system 200 to reduce the impact of the debris on the system 200 and process. The disposal system 216 may be integrated into the base 202. Alternatively, the disposal system may be integrated into the frame 201 or other portions of the system. It should be appreciated that the disposal system 216 may be configured to move debris away from the robotic arm 206. The disposal system 216 may have a funnel 218 configured to collect debris 226 and 228 from a large area and funnel it away from the robotic arm 206. In addition, the disposal system 216 may have a vacuum or similar suction device 220 configured to create a negative pressure to move the debris 226 and 228 with a force as indicated by arrow 223A.

In addition, the disposal system 216 may further include a fan 221, or similar blower device such as a pump or compressor that blows to push air, fluids, particulates, or other debris away from the device. The fan 221 may be integrated into the frame 201 or other aspect of the system and may be configured opposite the funnel 218. The fan 221 may create a downward force as indicated by arrow 223B when activated by the controller 224 to push the debris 226 and 228 away from the robotic arm 206 towards the funnel 218. The combination of the fan 221 and the vacuum 220 may effectively remove and limit buildup of debris within the finishing system 200. It should be appreciated in further embodiments, additional fans, pumps, vacuums, blower devices or suction devices for pushing or pulling fluids and debris may be contemplated.

The disposal system 216 may be fluidly coupled to an exhaust 222 configured to remove debris away from the finishing system 200. The exhaust 222 may transport debris to a waste receptacle or other disposal system for proper disposal. It should be appreciated that the controller 224 may also control the actuation or power of the vacuum 220 or fan 221 to activate the disposal system 216. Alternatively, other controllers may individually control each component. In other embodiments, it may be desirable to provide multiple disposal systems to more efficiently remove debris from the finishing system 200.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only. What is claimed is:

1. A multi-position finishing system comprising:
a base;
a frame coupled to the base;
a robotic arm operatively coupled to the frame approximately opposite the base, the robotic arm configured to hold an article of manufacture for finishing with at least one finishing process;
at least one finishing assembly operatively coupled to the base to perform the at least one finishing process on the article of manufacture, and create a least one form of waste; and
a disposal system coupled to the base, configured to collect the at least one form of waste from the finishing process.

2. The multi-position finishing system of claim 1, wherein the finishing assembly is rotatably coupled to the base by a rotary actuator.

3. The multi-position finishing system of claim 1, further comprising a suction device, the suction device fluidly coupled to the disposal system.

4. The multi-position finishing system of claim 1, further comprising a controller.

5. The multi-position finishing system of claim 4, wherein the controller is configured to control the robotic arm.

6. The multi-position finishing system of claim 5, wherein the controller is further configured to control the finishing assembly.

7. The multi-position finishing system of claim 6, wherein the controller is further configured to control the disposal system.

8. The multi-position finishing system of claim 1, wherein the disposal system comprises a funnel coupled to the base.

9. The multi-position finishing system of claim 1, wherein the disposal system comprises a suction device coupled to the base.

10. The multi-position finishing system of claim 9, wherein the disposal system further comprises a blower coupled to the frame opposite the suction device.

11. A method for finishing an article of manufacture comprising:
securing an article of manufacture with a robotic arm; the robotic arm manipulating a position of an article of manufacture towards a finishing assembly;
orienting the article of manufacture to a first orientation;
performing a finishing process on the article of manufacture, while the article of manufacture is held in the first orientation; and
activating a disposal system, the disposal system configured to move debris from the finishing process away from the robotic arm.

12. The method of claim 11, further comprising, orienting the article of manufacture to a second orientation, and performing a second finishing process on the article of manufacture in a second orientation

13. The method of claim 12, further comprising reorienting the finishing system.

14. The method of claim 13, wherein the finishing system is rotated about an axis by a rotary actuator.

15. The method of claim 14, wherein the finishing system is translated linearly by a linear actuator.

16. The method of claim 12 further comprising controlling the robotic arm and the finishing system with a controller.

17. The method of claim 16 further comprising controlling the disposal system with the controller.
